(19) United States
(12) Patent Application Publication
(10) Pub. No.: US 2026/0072735 A1
(43) Pub. Date: Mar. 12, 2026

(54) OPERATION ENVIRONMENT DEPLOYMENT METHOD AND SYSTEM

(71) Applicant: Kuo-Liang YU, Kaohsiung City (TW)

(72) Inventor: Kuo-Liang YU, Kaohsiung City (TW)

(21) Appl. No.: 19/319,071

(22) Filed: Sep. 4, 2025

(30) Foreign Application Priority Data
Sep. 6, 2024 (TW) 113133854

(51) Int. Cl. G06F 9/48; G06F 9/50

(52) U.S. Cl. CPC G06F 9/4881; G06F 9/5072; G06F 2209/486

(57) ABSTRACT

An operation environment deployment method, adapted to an operation environment including a work cell, wherein the work cell includes multiple equipment, and the method includes: obtaining a first current deployment status and a target deployment status of the operation environment from a cell model and performing problem planning, using pre-stored action chunks to perform domain planning, generating an action chunk sequence according to a pre-stored semantic scene graph, dismantling the action chunk sequence into target action features, obtaining a second current deployment status of the operation environment from the cell model, generating a configurable control graph according to the target action features and the second current deployment status, outputting control commands to the equipment according to the configurable control graph and obtaining corresponding feedback status, and building a three-dimensional geometric scene and a local semantic scene according to sensory data corresponding to the equipment.

### CROSS-REFERENCE TO RELATED APPLICATIONS

This non-provisional application claims priority under 35 U.S.C. § 119(a) on Patent Application No(s). 113133854 filed in Republic of China (Taiwan) on Sep. 6, 2024, the entire contents of which are hereby incorporated by reference.

### BACKGROUND

### 1. Technical Field

This disclosure relates to an operation environment deployment method and system.

### 2. Related Art

One of the problems to be solved in factory production is to enable various work cells (e.g., workstations) to operate in unstructured assembly environments in order to accomplish multiple tasks. In the process of planning the execution sequence of actions of a work cell in an unstructured environment, a new execution sequence must be replanned for each task, which is an inefficient planning approach. In addition, in existing methods, when performing manipulation tasks, a work cell starts operation only after the result of the task plan has been verified. Therefore, if the task environment changes during the computation period, the task may fail.

### SUMMARY

Accordingly, this disclosure provides an operation environment deployment method and system.

According to one or more embodiment of this disclosure, an operation environment deployment method, adapted to an operation environment comprising at least one work cell, wherein each of the at least one work cell comprises a plurality of pieces of equipment, and the operation environment deployment method, performed by at least one processing device, includes: obtaining a first current deployment status and a target deployment status of the operation environment from a cell model, wherein the cell model indicates a simulated environment corresponding to the operation environment; performing problem planning using the first current deployment status and the target deployment status, performing domain planning using a plurality of pre-stored action chunks, and generating an action chunk sequence according to a pre-stored semantic scene graph, wherein each of the plurality of pre-stored action chunks indicates a plurality of action combinations, and the pre-stored semantic scene graph indicates relationships between a plurality of objects in the operation environment; dismantling the action chunk sequence into a plurality of target action features according to relationship information of the plurality of pre-stored action chunks, wherein the plurality of target action features indicate a plurality of action of the at least one work cell, respectively; obtaining a second current deployment status of the operation environment from the cell model, and generating a configurable control graph according to the plurality of target action features and the second current deployment status, wherein the configurable control graph indicates an execution sequence and logic of a plurality of executable actions among the plurality of pieces of equipment of the at least one work cell; outputting a plurality of control commands to the plurality of pieces of equipment according to the configurable control graph, obtaining a plurality of pieces of feedback status of the plurality of pieces of equipment responding to the plurality of control commands, and importing the plurality of pieces of feedback status to the cell model; and obtaining a plurality of pieces of perception data corresponding to the plurality of pieces of equipment, and building a three-dimensional geometric scene graph and a local semantic scene graph by performing object detection and graph modeling according to the plurality of pieces of perception data.

According to one or more embodiment of this disclosure, an operation environment deployment system includes: at least one processing device and at least one memory. The at least one processing device is configured to perform the operation environment deployment method described above. The at least one memory is connected to the at least one processing device, and configured to store the cell model and the plurality of pre-stored action chunks.

In view of the above description, the operation environment deployment method and system according to one or more of the above embodiments may enable the work cell to reuse the action feature, so that the actions of the work cell may adapt to similar operation scenarios without the need to repeatedly plan the same task. Further, the operation environment deployment method and system according to one or more of the above embodiments may perform planning and generation based on the current deployment status of the environment, thereby reducing the risk of task failure due to environmental changes.

### BRIEF DESCRIPTION OF THE DRAWINGS

The present disclosure will become more fully understood from the detailed description given hereinbelow and the accompanying drawings which are given by way of illustration only and thus are not limitative of the present disclosure and wherein:

FIG. 1 is a block diagram illustrating an operation environment deployment system according to an embodiment of the present disclosure;

FIG. 2 is a structural diagram of a deployment framework for performing an operation environment deployment method according to an embodiment of the present disclosure;

FIG. 3 is a flowchart illustrating an operation environment deployment method according to an embodiment of the present disclosure; and

FIG. 4 is an interaction structural diagram of illustrating a synthesizer, an adaptor, an awarenor and a work cell according to an embodiment of the present disclosure.

### DETAILED DESCRIPTION

In the following detailed description, for purposes of explanation, numerous specific details are set forth in order to provide a thorough understanding of the disclosed embodiments. According to the description, claims and the drawings disclosed in the specification, one skilled in the art may easily understand the concepts and features of the present invention. The following embodiments further illustrate various aspects of the present invention, but are not meant to limit the scope of the present invention.

The operation environment deployment system and method of one or more embodiments described below is adapted to an operation environment comprising at least one work cell, wherein said at least one work cell may each be a working platform and include a plurality of pieces of equipment. For example, when the operation environment is an assembly scene, one work cell may include a plurality of pieces of equipment, such as a fixture, a robotic arm, a mobile carrier, a camera, etc., but the present disclosure is not limited thereto. Further, the assembly scene may include three stages, which are pre-assembly stage, assembly stage and post-assembly stage. The pre-assembly stage may include performing calibration on a workpiece, finding a workpiece and grasping a workpiece etc.; the assembly stage may include collecting assembly information in real-time and smart decision-making; and post-assembly stage may include inspecting and testing finished workpiece. The operation environment deployment system and method of the present application may be applicable to the three stages of the assembly scene described above, but the operation environment deployment system and method of the present application may also be applicable to other operation scene, the present disclosure is not limited thereto.

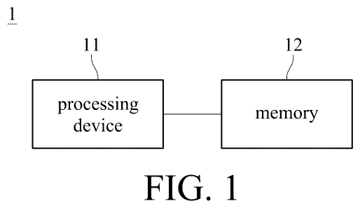

Please refer to FIG. 1, wherein FIG. 1 is a block diagram illustrating an operation environment deployment system according to an embodiment of the present disclosure. As shown in FIG. 1, the operation environment deployment system 1 includes at least one processing device 11 and at least one memory 12. The processing device 11 is electrically connected to or in communication connection with the memory 12.

The processing device 11 is configured to perform one or more embodiments of the operation environment deployment method described below. Further, in the embodiment where the number of the processing device 11 is one, the processing device 11 may be configured to perform all of the steps of the operation environment deployment method described below; and in the embodiment where the number of the processing device 11 is more than one, the processing devices 11 may be configured to perform one or more steps, respectively, of the operation environment deployment method described below. The processing device 11 may include one or more processors, the processor is, for example, a central processing unit (CPU), a graphics processing unit (GPU), a microcontroller, a programmable logic controller or any other processor with signal processing function.

The memory 12 is configured to store a cell model and a plurality of pre-stored action chunks used in the operation environment deployment method. The cell model indicates a simulated environment corresponding to the operation environment. The cell model may serve as a storage medium configured to store data of all objects in a real-world environment of the operation environment. The data may include, but not limited to, positional relationships between equipment and the workpiece, positional relationships between multiple pieces and sizes of the equipment and the workpiece etc. Each pre-stored action chunk may include at least one equipment control parameter for controlling the equipment and an action pattern of a plurality of pre-stored action features. The action pattern of the pre-stored action chunk may correspond to finding an object, approaching an object, grasping an object and moving an object etc. The pre-stored action features included in the action pattern may indicate a plurality of actions constituting the action pattern.

The memory 12 may be a non-volatile memory (NVM), such as flash memory, non-volatile random access memory (NVRAM), etc.

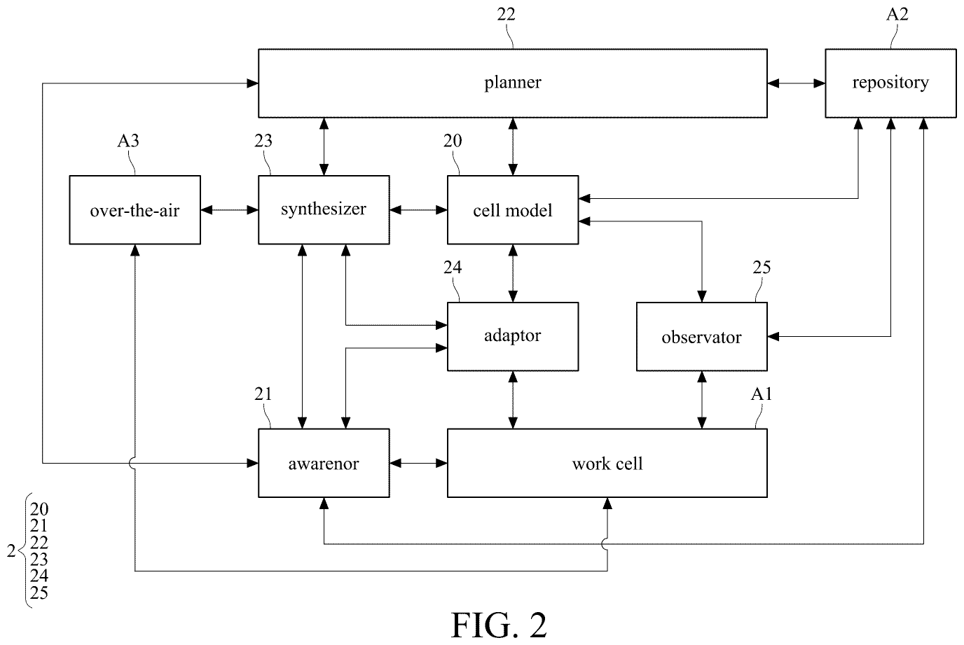

Please refer to FIG. 2, wherein FIG. 2 is a structural diagram of a deployment framework for performing an operation environment deployment method according to an embodiment of the present disclosure. As shown in FIG. 2, the deployment framework 2 includes a cell model 20, an awarenor 21, a planner 22, a synthesizer 23, an adaptor 24 and an observator 25, and may interact with the at least one work cell A1 in the operation environment, a repository A2 external to the operation environment and an over-the-air (OTA) A3. The work cell A1 may include a plurality of pieces of equipment as described above. The repository A2 may be, but not limited to, a cloud database, and may store data required during the operation of the deployment framework 2 and data generated after the operation of the deployment framework 2. It should be noted that FIG. 2 exemplarily illustrates one work cell A1, but the deployment framework 2 may also be applied to more than one work cell A1. It should be specifically noted that FIG. 2 exemplarily illustrates the communication between functional blocks as being bidirectional. However, in some embodiments, the communication paths between certain functional blocks may be unidirectional rather than limited to bidirectional.

The cell model 20 is connected to the planner 22, the synthesizer 23, the adaptor 24, the observator 25 and the repository A2; the awarenor 21 is further connected to the planner 22, the synthesizer 23 and the work cell A1; the planner 22 is further connected to the synthesizer 23 and the repository A2; the synthesizer 23 is further connected to the adaptor 24 and may deploy the software of the work cell A1 over the OTA A3; the adaptor 24 is further connected to the work cell A1; and the observator 25 is further connected to the repository A2 and the work cell A1. The number of each of the cell model 20 and the awarenor 21 may be one, and the number of each of the planner 22, the synthesizer 23, the adaptor 24 and the observator 25 may be one or more.

In an embodiment, the operation environment deployment system 1 shown in FIG. 1 includes one processing device 11, and the awarenor 21, the planner 22, the synthesizer 23, the adaptor 24 and the observator 25 may all be executed by the processing device 11. In an embodiment, the operation environment deployment system 1 shown in FIG. 1 includes a plurality of processing devices 11, and the planner 22, the synthesizer 23, the adaptor 24 and the observator 25 may each be executed by one processing device 11; or, a part of the planner 22, the synthesizer 23, the adaptor 24 and the observator 25 is executed by one processing device 11, and the rest are executed by other processing devices 11, respectively. Further, the cell model 20 and the awarenor 21 may be implemented by the memory 12 of FIG. 1. In other words, the awarenor 21 and the cell model 20 may be stored in the same memory 12; or, the awarenor 21 and the cell model 20 may be stored in two memories 12, respectively.

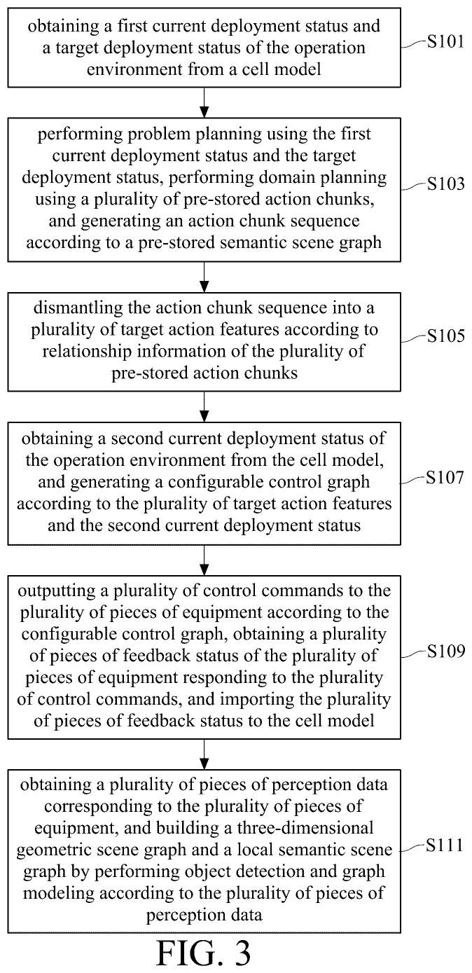

Please refer to FIG. 3, wherein FIG. 3 is a flowchart illustrating an operation environment deployment method according to an embodiment of the present disclosure. As shown in FIG. 3, the operation environment deployment method includes: step S101: obtaining a first current deployment status and a target deployment status of the operation environment from a cell model; step S103: performing problem planning using the first current deployment status and the target deployment status, performing domain planning using a plurality of pre-stored action chunks, and generating an action chunk sequence according to a pre-stored semantic scene graph; step S105: dismantling the action chunk sequence into a plurality of target action features according to relationship information of the plurality of pre-stored action chunks; step S107: obtaining a second current deployment status of the operation environment from the cell model, and generating a configurable control graph according to the plurality of target action features and the second current deployment status; step S109: outputting a plurality of control commands to the plurality of pieces of equipment according to the configurable control graph, obtaining a plurality of pieces of feedback status of the plurality of pieces of equipment responding to the plurality of control commands, and importing the plurality of pieces of feedback status to the cell model and step S111: obtaining a plurality of pieces of perception data corresponding to the plurality of pieces of equipment, and building a three-dimensional geometric scene graph and a local semantic scene graph by performing object detection and graph modeling according to the plurality of pieces of perception data. The following exemplarily explains the steps of FIG. 3 with the deployment framework of FIG. 2.

In step S101, the planner 22 obtains the first current deployment status and the target deployment status of the operation environment from the cell model 20. When the operation environment is first deployed, the first current deployment status may indicate the initialization status of the operation environment, for example, when the user selects initialization setting options through an input device (such as a mouse, keyboard, touchpad, etc.) that is connected, either wired or wirelessly, to the processing device running the planner 22. In the deployment of the operation environment, the first current deployment status may indicate the current status of the operation environment. That is, the first current deployment status may indicate the status updated into the cell model 20 by the adaptor 24 or the observator 25 according to the feedback status of the equipment at a later stage. The target deployment status may indicate the status that the operation environment should enter when executing a task (for example, assembly). The target deployment status may be set by the user through the input device (such as a mouse, keyboard, touchpad, etc.) that is connected, either wired or wirelessly, to the processing device running the planner 22. In the example where the equipment is a robotic arm, the deployment status described above may each include location information of the robotic arm in the simulated environment corresponding to the operation environment.

In step S103, the planner 22 uses the first current deployment status and the target deployment status to perform problem planning, uses the pre-stored action chunks to perform domain planning, and generates the action chunk sequence according to the pre-stored semantic scene graph. Problem planning may be used to parse the overall goal of the equipment according to the web ontology language (OWL), and domain planning may be used to parse the actions corresponding to the execution of the overall goal according to the web ontology language. The pre-stored action chunks indicate a plurality of action combinations, respectively. In the example where the equipment is a robotic arm, one action combination may indicate approaching a workpiece, grasping a workpiece or moving a workpiece etc. Each action combination may be formed by connecting a plurality of action features in sequence, wherein one action feature may indicate one action of the work cell A1, such as moving in a designated direction by a designated distance, rotating in a designated direction by a designated angle etc. The pre-stored semantic scene graph indicates relationships between the objects in the operation environment. The objects may include equipment, workpiece, operator and fixture etc. The relationship may include actions to be executed by the objects and the sequence of executing the actions. The pre-stored action chunks may be stored in the awarenor 21. The pre-stored action chunks in the awarenor 21 may be stored therein by an operator; or, the repository A2 may store the pre-stored action chunks, and the planner 22 may obtain the pre-stored action chunks from the repository A2 and import the pre-stored action chunks to the awarenor 21. The planner 22 may store the pre-stored semantic scene graph into the cell model 20. The pre-stored semantic scene graph in the cell model 20 may be stored therein by an operator; or, the repository A2 may store the pre-stored semantic scene graph, and the planner 22 may obtain the pre-stored semantic scene graph from the repository A2 and import the pre-stored semantic scene graph to the cell model 20. The planner 22 may sort the pre-stored action chunks according to the sequence of the actions indicated by the pre-stored semantic scene graph to generate the action chunk sequence.

In step S105, the synthesizer 23 dismantles the action chunk sequence into the target action features according to the relationship information of the pre-stored action chunks, wherein the target action features indicate a plurality of actions of the work cell A1, respectively. The relationship information may include the action pattern of the pre-stored action chunk, such as the sequence between the action features of the pre-stored action chunk. The target action features may be the action features of the action combination described above, and the target action features indicate actions of the work cell A1.

In step S107, the synthesizer 23 obtains the second current deployment status of the operation environment from the cell model 20, and generates the configurable control graph according to the target action features and the second current deployment status. The second current deployment status may be the current status of the work cell A1 in the operation environment. The configurable control graph indicates an execution sequence and logic of a plurality of executable actions between the plurality of pieces of equipment of the work cell A1. The executable action may be the action feature with both the execution sequence and the corresponding equipment conforming to the production line process. The synthesizer 23 uses the deployment status currently obtained to generate the configurable control graph, thereby reducing the risk of task failure caused by changes in the operation environment during the planning and generation process. The configurable control graph may be in the form of a decision tree including a plurality of nodes. Each node has an action reference corresponding to the executable action, the relationship between the nodes represents the execution sequence and logic, wherein the information indicated by the action reference is described below.

In an embodiment, in addition to generating the configurable control graph, the synthesizer 23 may further rollout a software required by the work cell A1 to the OTA A3 according to the pre-stored semantic scene graph. Therefore, the OTA A3 may schedule and dispatch the executable action to the equipment in order to complete a dynamic deployment of the executable environment

In step S109, the adaptor 24 outputs the control commands to the equipment according to the configurable control graph coming from the synthesizer 23, monitors the equipment to obtain the feedback status of the equipment responding to the control commands, and imports the feedback status to the cell model 20. Specifically, the adaptor 24 may generate the control commands (for example, control code) that can be read by the controller of the equipment according to the executable action indicated by the configurable control graph to control the equipment to execute the corresponding actions. The feedback status may indicate whether the equipment can execute the corresponding action according to the control command, and indicate the progress of the equipment executing the action. For example, the feedback status may be sensory feedback or/and action event. Further, the adaptor 24 may import the feedback status to the cell model 20 to update the pre-stored semantic scene graph in the cell model 20. In an embodiment, the adaptor 24 may generate control commands based on the control parameters and action references of the equipment of the pre-stored action chunks of the awarenor 21, and output the control commands to the equipment.

In addition, when any one of the feedback status indicates error status, the adaptor 24 may output a warning notification to notify the user that the equipment corresponding to the feedback status might experience a failure. The warning notification may be output through an output device (for example, a display, a warning light, a speaker, etc.) that is connected, either wired or wirelessly, to the processing device running the adaptor 24. Moreover, the processing device running the adaptor 24 may be further connected, either wired or wirelessly, to the input device, so that the user may adjust the content of the configurable control graph through the input device.

In step S111, the observator 25 obtains the perception data corresponding to the equipment, performs object detection (or object perception) and graph modeling to establish the 3D geometric scene graph and the local semantic scene graph of the cell model 20. The 3D geometric scene graph may represent the spatial information of the operation environment, including the specific location of the object in the operation environment. The local semantic scene graph may be used to represent the relative relationships between the objects in the operation environment. For example, cameras may be disposed in the operation environment to obtain images of the operation environment (for example, images of the work cell A1 executing the task) as the perception data. The observator 25 may perform object detection on the images to determine the locations and sizes of the object in the space, and convert the 2D detection result into the 3D geometric scene graph. The observator 25 may use convolutional neural network (CNN) to establish the 3D geometric scene graph, and input the 3D geometric scene graph to a graph neural network (GNN) to establish the local semantic scene graph. In an embodiment, the repository A2 may store domain knowledge, and the observator 25 may obtain the domain knowledge from the repository A2, and perform object detection and graph modeling with reference to the domain knowledge, thereby improving the accuracy. Further, the spatial geometric shapes of 3D geometric scene may be continuously analyzed to generate relational symbols concerning objects, the equipment, and operators. The relational symbols may include spatial relations, visibility, accessibility, and the like. The generation of the relational symbols may be performed by perceptual anchoring, and the relational symbols may be updated into the domain knowledge and the local semantic scene graph.

Accordingly, the operation environment deployment method and system according to one or more of the above embodiments may enable the work cell to reuse the action feature, so that the actions of the work cell may adapt to similar operation scenarios without the need to repeatedly plan the same task.

Further, the observator 25 may use the 3D geometric scene graph and the local semantic scene graph as a refreshed scene graph, store the refreshed scene graph into the cell model 20, and output the local semantic scene graph and the corresponding episode that is temporally annotated to the external repository A2. Therefore, information in the repository A2 may be synchronized with local side. After the observator 25 obtains the perception data and stores the refreshed scene graph into the cell model 20, the planner 22 may perform step S101 again.

In an embodiment, generating the configurable control graph according to the target action features and the second current deployment status in step S107 of FIG. 3 may include: performing path planning and geometric check on the plurality of target action features according to the second current deployment status to determine a plurality of executable action features; and generating a decision tree using the plurality of executable action features as the configurable control graph.

Specifically, the deployment status may be in the form of geometric values, and the synthesizer 23 may perform path planning and geometric check on the target action features with reference to the geometric values and geometric checker in the cell model 20, to determine one or more of the target action features as the executable action feature(s). Then, the synthesizer 23 may connect information corresponding to the executable action features in series as the decision tree, and use the decision tree as the configurable control graph.

In an embodiment, the synthesizer 23 may output a warning notification through the adaptor 24 to notify the user to step in when the synthesizer 23 determines, according to the target action features and the second current deployment status, that the path corresponding to the target action features cannot be generated or the equipment is unable to execute one or more of the action features. The warning notification may be output through an output device (for example, a display, a warning light, a speaker, etc.) that is connected, either wired or wirelessly, to the processing device running the adaptor 24. Moreover, the processing device running the adaptor 24 may be connected, either wired or wirelessly, to the input device, so that the user may adjust the content of the configurable control graph through the input device.

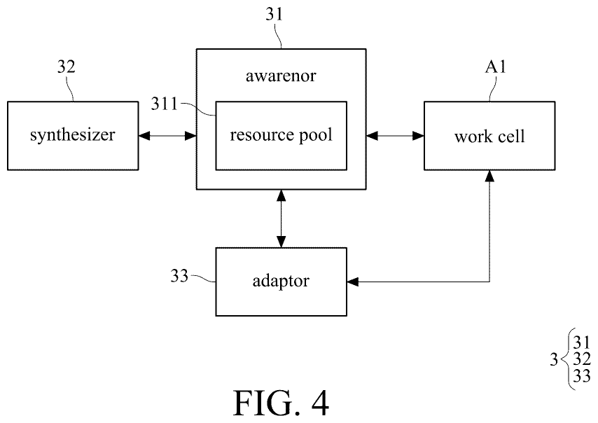

Please refer to FIG. 4, wherein FIG. 4 is an interaction structural diagram of illustrating a synthesizer, an adaptor, an awarenor and a work cell according to an embodiment of the present disclosure. As shown in FIG. 4, the deployment framework 3 includes an awarenor 31, a synthesizer 32 and an adaptor 33. The synthesizer 32 and the adaptor 33 may have the same operations as that of the synthesizer 23 and the adaptor 24 of FIG. 2, respectively, their descriptions are not repeated herein.

The awarenor 31 may include a resource pool 311, and the synthesizer 32 may generate the configurable control graph based on the resource of the resource pool 311. Moreover, generating the decision tree using the executable action features as the configurable control graph described above may include: taking each of the plurality of executable action features as a to-be-determined feature to perform: determining whether an available resource corresponding to the to-be-determined feature exists in the resource pool 311; taking first information as one of a plurality of nodes of the decision tree when the available resource corresponding to the to-be-determined feature exists in the resource pool 311, wherein the first information indicates the available resource; and defining a newly defined resource corresponding to the to-be-determined feature in the resource pool, and taking second information as one of a plurality of nodes of the decision tree when the available resource corresponding to the to-be-determined feature does not exist in the resource pool 311, wherein the second information indicates the newly defined resource.

The synthesizer 32 may sequentially use each one of the executable action features as the to-be-determined feature, and determine whether the resource pool 311 has the available resource corresponding to the to-be-determined feature. The available resource may be used as an action interface of the adaptor 33 monitoring the equipment executing the executable action. Specifically, the synthesizer 32 may determine whether the resource pool 311 has the available resource indicating an action reference of the to-be-determined feature. The action reference may be used to as an indicator of which to-be-determined feature that the available resource corresponds to.

The synthesizer 32 uses the first information indicating the available resource as one node of the decision tree when the available resource corresponding to the to-be-determined feature exists in the resource pool 311. The first information may include the above-described action reference or/and information (for example, address) of the available resource.

The synthesizer 32 establishes the newly defined resource corresponding to the to-be-determined feature in the resource pool 311 when the available resource corresponding to the to-be-determined feature is not present in the resource pool 311. That is, the synthesizer 32 assigns a resource to the action reference indicating the to-be-determined feature, and uses the second information indicating the newly defined resource as one node of the decision tree wherein the second information may include information of the above described action reference and the newly defined resource, such as address. In addition, the adaptor 33 may release the available resource or the newly defined resource that is used as a node into the resource pool 311 after receiving the feedback status responded by the equipment of the work cell A1.

In short, generating the decision tree as the configurable control graph by using the executable action features may include related information of the resource in the resource pool 311. That is, the executable actions indicated by the configurable control graph may correspond to the available resources in the resource pool 311. In a manner where first determining whether there is available resource corresponding to the executable action feature exists in the resource pool 311 during the process of generating the configurable control graph, existing resources are used if available and new resources are added if not, the system resources may be partitioned and controlled without excessive expansion, thereby improving the efficiency of resource linkage.

In addition, outputting the control commands to the equipment of the work cell A1 according to the configurable control graph and obtaining the feedback status of the plurality of pieces of equipment responding to the control commands performed by the adaptor 33 may be performed through the available resources in the resource pool 311 indicated by the configurable control graph. That is, the adaptor 33 may use the available resources indicated by the configurable control graph as the action interface to output the control commands to the equipment of the work cell A1 and obtain the feedback status responded by the equipment.

It should be noted that the deployment framework 3 may further include the cell model 20, the planner 22 and the observator 25 shown in FIG. 2, and the connection relationships between other modules in the deployment framework 3 with the cell model 20, the planner 22 and the observator 25 may be the same as that of FIG. 2.

In an embodiment, the operation environment deployment method according to the present disclosure may further include performing, for another target deployment status, steps that are the same as steps S103, S105, S107, S109, and S111 described above, by using the first current deployment status of the same cell model as described above or another cell model. The steps for said another target deployment status may be performed before or after steps S103, S105, S107, S109, and S111 for the target deployment status, or may be performed simultaneously. In the embodiment of simultaneously performing the steps, a plurality of software modules in the deployment framework (except for the cell model and the awarenor) may be provided, while the number of the cell model and the awarenor may be one or more, and the plurality of software modules may share the same cell model and the awarenor.

In view of the above description, the operation environment deployment method and system according to one or more of the above embodiments may enable the work cell to reuse the action feature, so that the actions of the work cell may adapt to similar operation scenarios without the need to repeatedly plan the same task. Further, the operation environment deployment method and system according to one or more of the above embodiments may perform planning and generation based on the current deployment status of the environment, thereby reducing the risk of task failure due to environmental changes. Furthermore, by performing path planning and geometric checking for the target action features, the execution sequence of the actions of the work cell may be ensured to be correct. During the process of generating the configurable control graph, whether an available resource corresponding to the executable action feature already exists in the resource pool is first determined; if available, the resource is reused, and if not, a new resource is added. In this manner, the system resources may be partitioned and controlled without excessive expansion.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. An operation environment deployment method, adapted to an operation environment comprising at least one work cell, wherein each of the at least one work cell comprises a plurality of pieces of equipment, and the operation environment deployment method, performed by at least one processing device, comprising:
obtaining a first current deployment status and a target deployment status of the operation environment from a cell model, wherein the cell model indicates a simulated environment corresponding to the operation environment;
performing problem planning using the first current deployment status and the target deployment status, performing domain planning using a plurality of pre-stored action chunks, and generating an action chunk sequence according to a pre-stored semantic scene graph, wherein each of the plurality of pre-stored action chunks indicates a plurality of action combinations, and the pre-stored semantic scene graph indicates relationships between a plurality of objects in the operation environment;
dismantling the action chunk sequence into a plurality of target action features according to relationship information of the plurality of pre-stored action chunks, wherein the plurality of target action features indicate a plurality of action of the at least one work cell, respectively;
obtaining a second current deployment status of the operation environment from the cell model, and generating a configurable control graph according to the plurality of target action features and the second current deployment status, wherein the configurable control graph indicates an execution sequence and logic of a plurality of executable actions among the plurality of pieces of equipment of the at least one work cell;
outputting a plurality of control commands to the plurality of pieces of equipment according to the configurable control graph, obtaining a plurality of pieces of feedback status of the plurality of pieces of equipment responding to the plurality of control commands, and importing the plurality of pieces of feedback status to the cell model; and
obtaining a plurality of pieces of perception data corresponding to the plurality of pieces of equipment, and building a three-dimensional geometric scene graph and a local semantic scene graph by performing object detection and graph modeling according to the plurality of pieces of perception data.

2. The operation environment deployment method according to claim 1, wherein generating the configurable control graph according to the plurality of target action features and the second current deployment status comprises:
performing path planning and geometric check on the plurality of target action features according to the second current deployment status to determine a plurality of executable action features; and
generating a decision tree using the plurality of executable action features as the configurable control graph.

3. The operation environment deployment method according to claim 2, wherein generating the decision tree using the plurality of executable action features as the configurable control graph comprises:
taking each of the plurality of executable action features as a to-be-determined feature to perform:
determining whether an available resource corresponding to the to-be-determined feature exists in a resource pool;
taking first information as one of a plurality of nodes of the decision tree when the available resource corresponding to the to-be-determined feature exists in the resource pool, wherein the first information indicates the available resource; and
defining a newly defined resource corresponding to the to-be-determined feature in the resource pool, and taking second information as one of a plurality of nodes of the decision tree when the available resource corresponding to the to-be-determined feature does not exist in the resource pool, wherein the second information indicates the newly defined resource.

4. The operation environment deployment method according to claim 1, wherein the plurality of executable actions indicated by the configurable control graph correspond to a plurality of available resources in a resource pool, and outputting the plurality of control commands to the plurality of pieces of equipment according to the configurable control graph, obtaining the plurality of pieces of feedback status responded by the plurality of pieces of equipment is performed through the plurality of available resources.

5. The operation environment deployment method according to claim 1, wherein the pre-stored semantic scene graph is obtained from an external repository, and the operation environment deployment method further comprises:
outputting the local semantic scene graph and a temporally annotated episode to the external repository.

6. The operation environment deployment method according to claim 1, further comprising: rolling out a software required by the at least one work cell to an over-the-air according to the pre-stored semantic scene graph.

7. The operation environment deployment method according to claim 1, wherein each of the plurality of pre-stored action chunks further comprises at least one equipment control parameter and an action pattern of a plurality of pre-stored action features.

8. The operation environment deployment method according to claim 1, further comprising:
outputting a warning notification when determining that a path corresponding to the plurality of target action features cannot be generated or the plurality of pieces of equipment are unable to execute one or more of the plurality of action features according to the plurality of target action features and the second current deployment status.

9. The operation environment deployment method according to claim 1, further comprising:
outputting a warning notification when any one of the plurality of pieces of feedback status indicates an error status.

10. An operation environment deployment system, comprising:
at least one processing device configured to perform the operation environment deployment method of claim 1; and
at least one memory connected to the at least one processing device, and configured to store the cell model and the plurality of pre-stored action chunks.

11. An operation environment deployment system, comprising:
at least one processing device configured to perform the operation environment deployment method of claim 2; and
at least one memory connected to the at least one processing device, and configured to store the cell model and the plurality of pre-stored action chunks.

12. An operation environment deployment system, comprising:
at least one processing device configured to perform the operation environment deployment method of claim 3; and
at least one memory connected to the at least one processing device, and configured to store the cell model and the plurality of pre-stored action chunks.

13. An operation environment deployment system, comprising:
at least one processing device configured to perform the operation environment deployment method of claim 4; and
at least one memory connected to the at least one processing device, and configured to store the cell model and the plurality of pre-stored action chunks.

14. An operation environment deployment system, comprising:
at least one processing device configured to perform the operation environment deployment method of claim 5; and
at least one memory connected to the at least one processing device, and configured to store the cell model and the plurality of pre-stored action chunks.

15. An operation environment deployment system, comprising:
at least one processing device configured to perform the operation environment deployment method of claim 6; and
at least one memory connected to the at least one processing device, and configured to store the cell model and the plurality of pre-stored action chunks.

16. An operation environment deployment system, comprising:
at least one processing device configured to perform the operation environment deployment method of claim 7; and
at least one memory connected to the at least one processing device, and configured to store the cell model and the plurality of pre-stored action chunks.

17. An operation environment deployment system, comprising:
at least one processing device configured to perform the operation environment deployment method of claim 8; and
at least one memory connected to the at least one processing device, and configured to store the cell model and the plurality of pre-stored action chunks.

18. An operation environment deployment system, comprising:
at least one processing device configured to perform the operation environment deployment method of claim 9; and
at least one memory connected to the at least one processing device, and configured to store the cell model and the plurality of pre-stored action chunks.
